(19) United States
(12) Patent Application Publication
(10) Pub. No.: US 2022/0102102 A1
(43) Pub. Date: Mar. 31, 2022

(54) RELAY

(71) Applicant: OMRON Corporation, Kyoto-shi, Kyoto (JP)

(72) Inventors: Yasuo HAYASHIDA, Kumamoto-shi, Kumamoto (JP); Ryota MINOWA, Yamaga-shi, Kumamoto (JP); Shingo MORI, Yamaga-shi, Kumamoto (JP); Naoki KAWAGUCHI, Yame-shi, Fukuoka (JP); Kohei OTSUKA, Omuta-shi, Fukuoka (JP); Hiroyuki IWASAKA, Kamimashiki-gun, Kumamoto (JP)

(21) Appl. No.: 17/421,725

(22) PCT Filed: Nov. 18, 2019
(86) PCT No.: PCT/JP2019/045033

§ 371 Date: Jul. 9, 2021

(30) Foreign Application Priority Data
Jan. 18, 2019 (JP) 2019-006529

(51) Int. Cl. H01H 50/18; H01H 50/54

(52) U.S. Cl. CPC H01H 50/18; H01H 50/02; H01H 50/546

(57) ABSTRACT

A relay includes first and second fixed contacts, first and second fixed terminals, first and second movable contacts, a movable contact piece, a drive shaft, a stopper, and a housing. The drive shaft supports the movable contact piece to be movable relative to the drive shaft. The stopper is connected to the drive shaft above the movable contact piece. The stopper restricts an upward movement of the movable contact piece with respect to the drive shaft. The drive shaft is configured to move to an open position and a closed position. The closed position is located above the open position. The first fixed terminal includes a first uppermost portion in the housing. The second fixed terminal includes a second uppermost portion in the housing. In a state where the drive shaft is at the closed position, the stopper is located below the first uppermost portion and the second uppermost portion.

### CROSS-REFERENCE TO RELATED APPLICATION

This application is the U.S. National Phase of International Application No. PCT/JP2019/045033, filed on Nov. 18, 2019. This application claims priority to Japanese Patent Application No. 2019-006529, filed Jan. 18, 2019. The contents of those applications are incorporated by reference herein in their entireties.

### FIELD

The present invention relates to a relay.

### BACKGROUND

There is a relay provided with a stopper on a drive shaft (see, for example, Japanese Patent Publication No. 6260893). The drive shaft is connected to a movable contact piece. The movable contact piece is supported by the drive shaft so as to be movable relative to the drive shaft. The stopper is provided, for example, at the upper end of the drive shaft. The stopper restricts the upward movement of the movable contact piece with respect to the drive shaft.

### SUMMARY

The stopper moves with the drive shaft. Therefore, the housing needs to be large enough to avoid interference with the stopper. Therefore, the moving range of the stopper becomes a factor of increasing the size of the housing. An object of the present invention is to reduce a size of a housing in a relay provided with a stopper on a drive shaft.

A relay according to one aspect includes a first fixed contact, a second fixed contact, a first fixed terminal, a second fixed terminal, a first movable contact, a second movable contact, a movable contact piece, a drive shaft, a stopper, and a housing. The second fixed contact is arranged apart from the first fixed contact in a left-right direction. The first fixed contact is connected to the first fixed terminal. The second fixed contact is connected to the second fixed terminal. The first movable contact is arranged below the first fixed contact. The second movable contact is arranged below the second fixed contact. The first movable contact and the second movable contact are connected to the movable contact piece. The movable contact piece is arranged so as to be movable in a vertical direction. The drive shaft extends in the vertical direction from the movable contact piece. The drive shaft supports the movable contact piece so as to be relatively movable. The stopper is connected to the drive shaft at a position above the movable contact piece. The stopper restricts an upward movement of the movable contact piece with respect to the drive shaft. The housing houses the first fixed terminal, the second fixed terminal, the movable contact piece, the drive shaft, and the stopper.

The drive shaft is configured to move to an open position and a closed position. When the drive shaft is at the open position, the first movable contact is separated from the first fixed contact, and the second movable contact is separated from the second fixed contact. The closed position is located above the open position. When the drive shaft is at the closed position, the first movable contact contacts the first fixed contact, and the second movable contact contacts the second fixed contact. When the drive shaft is at the closed position, the stopper is located below an uppermost portion of the first fixed terminal and an uppermost portion of the second fixed terminal in the housing.

In the relay according to the present aspect, when the drive shaft is at the closed position, the stopper is located below the uppermost portion of the first fixed terminal and the uppermost portion of the second fixed terminal in the housing. Therefore, the first fixed terminal, the second fixed terminal, and the stopper can be compactly arranged in the housing. Thereby, the housing can be miniaturized.

The drive shaft may be configured to move from the open position to the closed position via a contact start position. When the drive shaft is at the contact start position, the movable contact may begin to contact the fixed contact. The closed position may be located above the contact start position. In this case, the drive shaft moves further upward from the contact start position and moves to the closed position. However, when the drive shaft is at the closed position, the stopper is located below the uppermost portion of the first fixed terminal and the uppermost portion of the second fixed terminal in the housing. Therefore, the housing can be miniaturized even if the moving range of the stopper is wide.

In a state where at least one of the first movable contact, the first fixed contact, the second movable contact, and the second fixed contact is lost and the drive shaft is located above the closed position, the stopper may be located below the uppermost portion of the first fixed terminal and the uppermost portion of the second fixed terminal in the housing. When at least one of the first movable contact, the first fixed contact, the second movable contact, and the second fixed contact is lost, the drive shaft moves further upward than the closed position to secure energization of the movable contact piece, the first fixed terminal, and the second fixed terminal. Further, even if the drive shaft moves to a position further above the closed position, the stopper is located below the uppermost portion of the first fixed terminal and the uppermost portion of the second fixed terminal in the housing. Therefore, the housing can be miniaturized.

The movable contact piece may include a first portion, a second portion and a third portion. The first portion may support the first movable contact. The second portion may support the second movable contact. The third portion may be located between the first portion and the second portion. The drive shaft may be connected to the third portion. The third portion may be located below the first and second portions. In this case, the stopper can be arranged at a lower position than in the case where the third portion is linearly aligned with the first portion and the second portion. Therefore, the housing can be miniaturized.

The first fixed terminal and the second fixed terminal may project outward from the housing in a direction perpendicular to the vertical direction. In this case, there is less space in the housing in the vertical direction than in the case where the first fixed terminal and the second fixed terminal project upward from the housing. Therefore, the characteristics of the relay according to the present aspect are more effective.

The first fixed terminal may include a first contact support portion. The first fixed contact may be connected to the first contact support portion. The second fixed terminal may include a second contact support portion. The second fixed contact may be connected to the second contact support portion. The first contact support portion may extend in a direction perpendicular to the vertical direction. The second contact support portion may extend in a direction perpendicular to the vertical direction. In this case, there is less space in the housing in the vertical direction than in the case where the first contact support portion and the second contact support portion extend in the vertical direction. Therefore, the characteristics of the relay according to the present aspect are more effective.

A relay according to another aspect includes a first fixed contact, a second fixed contact, a first fixed terminal, a second fixed terminal, a first movable contact, a second movable contact, a movable contact piece, a shaft, a stopper, and a housing. The second fixed contact is arranged apart from the first fixed contact in a left-right direction. The first fixed contact is connected to the first fixed terminal. The second fixed contact is connected to the second fixed terminal. The first movable contact is arranged above the first fixed contact. The second movable contact is arranged above the second fixed contact. The first movable contact and the second movable contact are connected to the movable contact piece. The movable contact piece is arranged so as to be movable in the vertical direction. The drive shaft extends in the vertical direction from the movable contact piece. The drive shaft supports the movable contact piece so as to be relatively movable. The stopper is connected to the drive shaft at a position above the movable contact piece. The stopper restricts an upward movement of the movable contact piece with respect to the drive shaft. The housing houses the first fixed terminal, the second fixed terminal, the movable contact piece, the drive shaft, and the stopper.

The drive shaft is configured to move to an open position and a closed position. When the drive shaft is at the open position, the first movable contact is separated from the first fixed contact, and the second movable contact is separated from the second fixed contact. The open position is located above the closed position. When the drive shaft is at the closed position, the first movable contact contacts the first fixed contact, and the second movable contact contacts the second fixed contact. When the drive shaft is at the open position, the stopper is located below an uppermost portion of the first fixed terminal and an uppermost portion of the second fixed terminal in the housing.

In the relay according to the present aspect, when the drive shaft is at the open position, the stopper is located below the uppermost portion of the first fixed terminal and the uppermost portion of the second fixed terminal in the housing. Therefore, the first fixed terminal, the second fixed terminal, and the stopper can be compactly arranged in the housing. Thereby, the housing can be miniaturized.

### BRIEF DESCRIPTION OF THE DRAWINGS

FIG. 1 is a side sectional view showing a relay in an open state according to an embodiment.

FIG. 2 is a side sectional view showing the relay in a closed state.

FIG. 3 is an enlarged view of a contact device when a movable contact begins to contact a fixed contact.

FIG. 4 is an enlarged view of the contact device in the closed state.

FIG. 5 is a diagram showing a part of the relay according to a first modification.

FIG. 6 is a diagram showing a part of the relay according to a second modification.

FIG. 7 is a diagram showing a part of the relay according to the second modification.

FIG. 8 is a diagram showing a part of the relay according to a third modification.

FIG. 9 is a diagram showing a part of the relay according to the third modification.

### DETAILED DESCRIPTION

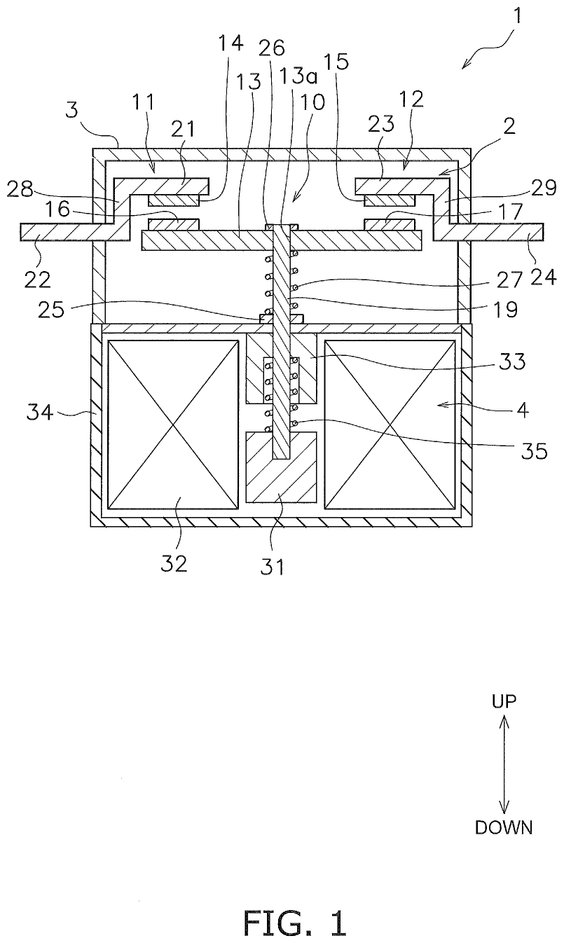

Hereinafter, the relay 1 according to an embodiment will be described with reference to the drawings. FIG. 1 is a side sectional view showing the relay 1 according to the embodiment. As shown in FIG. 1, the relay 1 includes a contact device 2, a housing 3, and a drive device 4.

In the following description, each direction of up/down/left/right means each direction of up/down/left/right in FIG. 1. Specifically, the direction from the drive device 4 to the contact device 2 is defined as upward. Further, the direction from the contact device 2 to the drive device 4 is defined as downward. In FIG. 1, a direction that intersects in a vertical direction is defined as a left-right direction. Further, a direction intersecting the vertical direction and the left-right direction is defined as a front-rear direction. The front-rear direction is a direction perpendicular to a paper surface of FIG. 1. However, these directions are defined for convenience of explanation, and do not limit the arrangement direction of the relay 1.

The contact device 2 is arranged in the housing 3. The contact device 2 includes a movable mechanism 10, a first fixed terminal 11, a second fixed terminal 12, a movable contact piece 13, a first fixed contact 1, a second fixed contact 15, a first movable contact 16, and a second movable contact 17. The first fixed terminal 11 and the second fixed terminal 12 are made of a conductive material such as copper. The fixed contacts 14 and 15 are provided separately from the fixed terminals 11 and 12. The first fixed contact 14 is connected to the first fixed terminal 11. The second fixed contact 15 is connected to the second fixed terminal 12. The first fixed contact 14 and the second fixed contact 15 are arranged apart from each other in the left-right direction. The first fixed contact 14 and the second fixed contact 15 are made of a conductive material such as copper.

The first fixed terminal 11 has a bent plate-like shape. The first fixed terminal 11 includes a first contact support portion 21, a first intermediate portion 28, and a first external terminal portion 22. The first contact support portion 21 faces the movable contact piece 13. The first fixed contact 14 is connected to the first contact support portion 21. The first contact support portion 21 extends in the left-right direction. The first intermediate portion 28 is located between the first contact support portion 21 and the first external terminal portion 22. The first intermediate portion 28 extends in the vertical direction. The first external terminal portion 22 is connected to the first contact support portion 21. The first external terminal portion 22 projects outward from the housing 3. A part of the first external terminal portion 22, the first contact support portion 21, and the first intermediate portion 28 are arranged in the housing 3.

The second fixed terminal 12 has a bent plate-like shape. The second fixed terminal 12 includes a second contact support portion 23, a second intermediate portion 29, and a second external terminal portion 24. The second contact support portion 23 faces the movable contact piece 13. The second fixed contact 15 is connected to the second contact support portion 23. The second contact support portion 23 extends in the left-right direction. The second intermediate portion 29 is located between the second contact support portion 23 and the second external terminal portion 24. The second intermediate portion 29 extends in the vertical direction. The second external terminal portion 24 is connected to the second contact support portion 23. The second external terminal portion 24 projects outward from the housing 3. Specifically, the first external terminal portion 22 and the second external terminal portion 24 project from the housing 3 in the left-right direction. A part of the second external terminal portion 24, the second contact support portion 23, and the second intermediate portion 29 are arranged in the housing 3.

The movable contact piece 13 is made of a conductive material such as copper. The movable contact piece 13 extends in the left-right direction. In the present embodiment, a longitudinal direction of the movable contact piece 13 coincides with the left-right direction. The movable contact piece 13 is arranged to face the first contact support portion 21 of the first fixed terminal 11 and the second contact support portion 23 of the second fixed terminal 12 in the vertical direction.

The movable contact piece 13 is arranged so as to be movable in the vertical direction. As the movable contact piece 13 moves upward, the movable contact piece 13 comes close to the first fixed terminal 11 and the second fixed terminal 12. As the movable contact piece 13 moves downward, the movable contact piece 13 is separated from the first fixed terminal 11 and the second fixed terminal 12.

The first movable contact 16 and the second movable contact 17 are provided separately from the movable contact piece 13. The first movable contact 16 and the second movable contact 17 are connected to the movable contact piece 13. The first movable contact 16 and the second movable contact 17 are made of a conductive material such as copper. The first movable contact 16 and the second movable contact 17 are arranged apart from each other in the left-right direction. The first movable contact 16 faces the first fixed contact 14 in the vertical direction. The first movable contact 16 is arranged below the first fixed contact 14. The second movable contact 17 faces the second fixed contact 15 in the vertical direction. The second movable contact 17 is arranged below the second fixed contact 15.

The movable mechanism 10 supports the movable contact piece 13. The movable mechanism 10 is arranged so as to be movable in the vertical direction together with the movable contact piece 13. The movable mechanism 10 includes a drive shaft 19, a holder 25, a stopper 26, and a contact spring 27. The drive shaft 19 extends in the vertical direction from the movable contact piece 13. The drive shaft 19 is connected to the movable contact piece 13. The movable contact piece 13 is provided with a hole 13a. The drive shaft 19 is inserted into the hole 13a. The movable contact piece 13 is movable relative to the drive shaft 19 in the vertical direction.

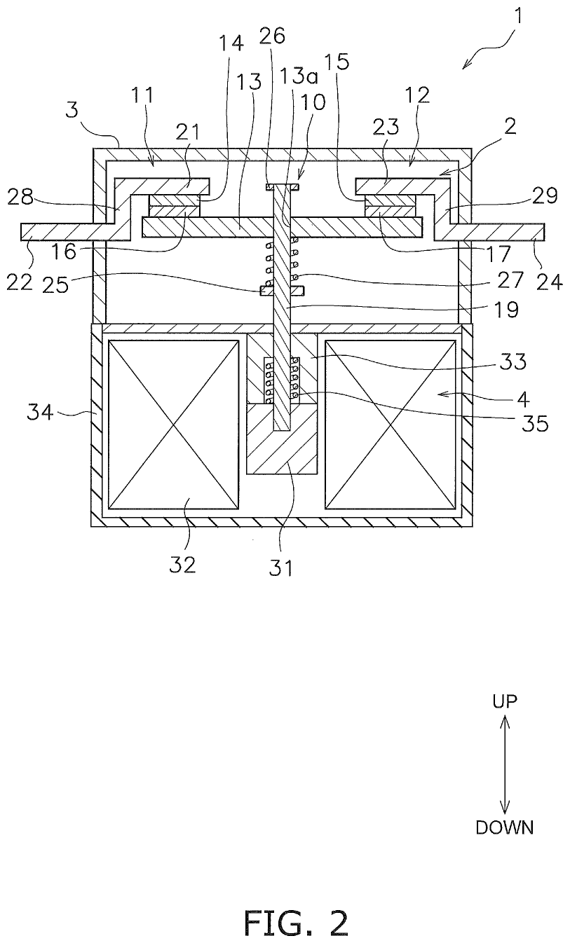

The drive shaft 19 is movably provided at a closed position and an open position. FIG. 1 shows the drive shaft 19 at the open position. As shown in FIG. 1, when the drive shaft 19 is at the open position, the movable contacts 16 and 17 are separated from the fixed contacts 14 and 15. FIG. 2 shows the drive shaft 19 at the closed position. As shown in FIG. 2, when the drive shaft 19 is at the closed position, the movable contacts 16 and 17 contacts the fixed contacts 14 and 15. The closed position is located above the open position.

The holder 25 is fixed to the drive shaft 19. The holder 25 is arranged below the movable contact piece 13. The contact spring 27 is arranged between the movable contact piece 13 and the holder 25. The contact spring 27 urges the movable contact piece 13 upward when the drive shaft 19 is at the closed position. The stopper 26 is fixed to the drive shaft 19. The stopper 26 is connected to an upper end of the drive shaft 19. The stopper 26 may be provided separately from the drive shaft 19. Alternatively, the stopper 26 may be integrated with the drive shaft 19. The stopper 26 is arranged above the movable contact piece 13. The stopper 26 restricts the upward movement of the movable contact piece 13 with respect to the drive shaft 19.

The drive device 4 operates the movable contact piece 13 by an electromagnetic force. The drive device 4 moves the movable mechanism 10 in the vertical direction. As a result, the drive device 4 moves the movable contact piece 13 in the vertical direction. The drive device 4 includes a movable iron core 31, a coil 32, a fixed iron core 33, a yoke 34, and a return spring 35.

The movable iron core 31 is connected to the drive shaft 19. The movable iron core 31 is provided so as to be movable in the vertical direction. The coil 32 generates an electromagnetic force that moves the movable iron core 31 upward when the coil 32 is energized. The fixed iron core 33 is arranged so as to face the movable iron core 31. The return spring 35 is arranged between the movable iron core 31 and the fixed iron core 33. The return spring 35 urges the movable iron core 31 downward.

The yoke 34 is arranged so as to surround the coil 32. The yoke 34 is arranged on a magnetic circuit formed by the coil 32. The yoke 34 is arranged above the coil 32, on the lateral side of the coil 32, and below the coil 32.

Next, the operation of the relay 1 will be described. When the coil 32 is not energized, the drive device 4 is not magnetized. In this case, the drive shaft 19 is pressed downward by the elastic force of the return spring 35 together with the movable iron core 31. Therefore, the drive shaft 19 is located at the open position shown in FIG. 1. In this state, the movable contact piece 13 is also pressed downward via the movable mechanism 10. Therefore, when the drive shaft 19 is at the open position, the first movable contact 16 and the second movable contact 17 are separated from the first fixed contact 14 and the second fixed contact 15.

When the coil 32 is energized, the drive device 4 is magnetized. In this case, the movable iron core 31 moves upward due to the electromagnetic force of the coil 32 against the elastic force of the return spring 35. As a result, the drive shaft 19 and the movable contact piece 13 both move upward. Therefore, as shown in FIG. 2, the drive shaft 19 moves to the closed position. As a result, when the drive shaft 19 is at the closed position, the first movable contact 16 and the second movable contact 17 contact the first fixed contact 14 and the second fixed contact 15, respectively.

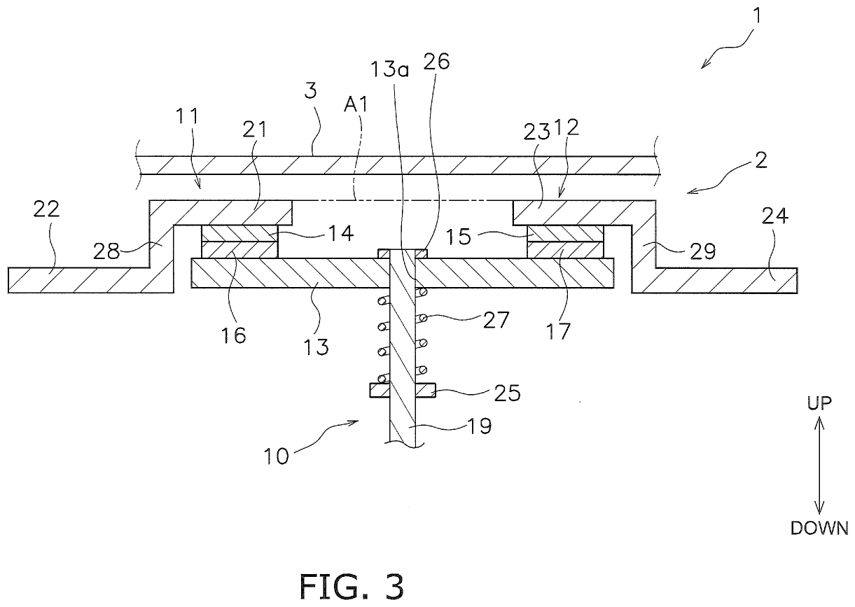

Specifically, the drive shaft 19 moves from the open position to the closed position via a contact start position. FIG. 3 shows the drive shaft 19 at the contact start position. The contact start position is located between the closed position and the open position in the vertical direction. The closed position is located above the contact start position.

As shown in FIG. 3, when the drive shaft 19 is at the contact start position, the movable contacts 16 and 17 begin to contact the fixed contacts 14 and 15. That is, before the drive shaft 19 reaches the closed position, the first movable contact 16 and the second movable contact 17 contact the first fixed contact 14 and the second fixed contact 15, respectively. As a result, the upward movement of the movable contact piece 13 is restricted.

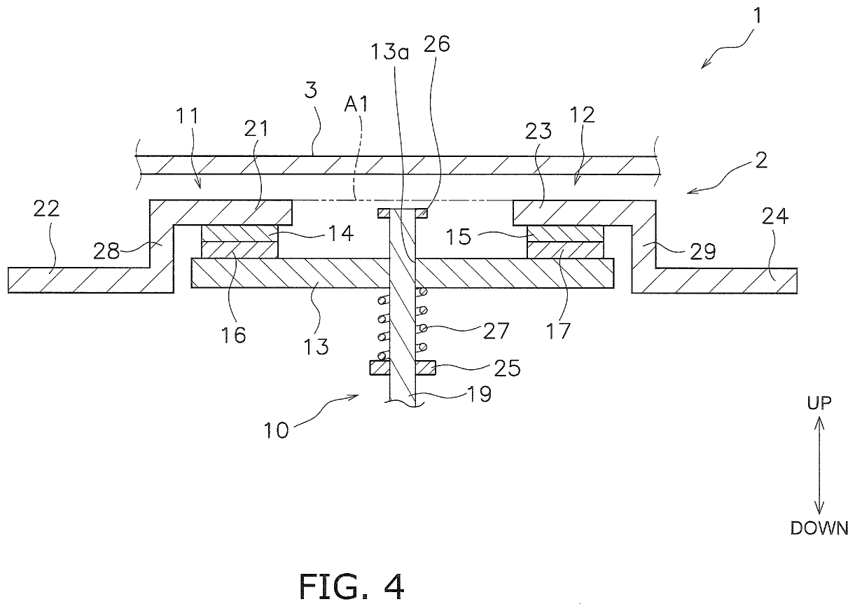

FIG. 4 shows the drive shaft 19 at the closed position. As shown in FIG. 4, when the drive shaft 19 moves further upward from the contact start position, the drive shaft 19 moves upward with respect to the movable contact piece 13. As a result, the distance between the holder 25 and the movable contact piece 13 is reduced, and the contact spring 27 is compressed. Therefore, when the drive shaft 19 is at the closed position, the contact spring 27 urges the movable contact piece 13 upward. Thereby, the contact pressure of the contacts can be increased.

In FIG. 4, A1 shows a position of an uppermost portion of the first fixed terminal 11 and an uppermost portion of the second fixed terminal 12 in the housing 3. In the present embodiment, the uppermost portion of the first fixed terminal 11 in the housing 3 is the upper surface of the first contact support portion 21. The uppermost portion of the second fixed terminal 12 in the housing 3 is the upper surface of the second contact support portion 23. As shown in FIG. 4, when the drive shaft 19 is at the closed position, the stopper 26 is located below the position A1 of the uppermost portions. Therefore, the uppermost position in the moving range of the stopper 26 is located below the position A1 of the uppermost portions.

When the current to the coil 32 is stopped and degaussed, the movable iron core 31 is pressed downward by the elastic force of the return spring 35. As a result, the drive shaft 19 and the movable contact piece 13 both move downward. Therefore, as shown in FIG. 1, the drive shaft 19 moves to the open position. As a result, the first movable contact 16 and the second movable contact 17 are separated from the first fixed contact 14 and the second fixed contact 15.

In the relay 1 according to the present embodiment described above, when the drive shaft 19 is at the closed position, the stopper 26 is below the position A1 of the uppermost portions of the first fixed terminal 11 and the second fixed terminal 12 in the housing 3. Therefore, the first fixed terminal 11, the second fixed terminal 12, and the stopper 26 can be compactly arranged in the housing 3. Thereby, the housing 3 can be miniaturized.

Although one embodiment of the present invention has been described above, the present invention is not limited to the above embodiment, and various modifications can be made without departing from the gist of the invention.

The shape or arrangement of the first fixed terminal 11 and the second fixed terminal 12 may be changed. For example, the first contact support portion 21 and the second contact support portion 23 may extend in the front-rear direction. The first contact support portion 21 and the second contact support portion 23 may extend in the vertical direction. The first intermediate portion 28 and the second intermediate portion 29 may extend in the left-right direction. The first intermediate portion 28 and the second intermediate portion 29 may extend in the front-rear direction. The first external terminal portion 22 and the second external terminal portion 24 may protrude from the housing 3 in the front-rear direction. The first external terminal portion 22 and the second external terminal portion 24 may project upward from the housing 3. The first fixed terminal 11 and the second fixed terminal 12 are not limited to the bent shape as in the above embodiment, but may have a linear shape.

The shape or arrangement of the movable iron core 31, the coil 32, the fixed iron core 33, or the yoke 34 may be changed. The shapes or arrangements of the first fixed contact 14, the second fixed contact 15, the first movable contact 16, and the first fixed contact 14 may be changed.

The first fixed contact 14 may be integrated with the first fixed terminal 11. The second fixed contact 15 may be integrated with the second fixed terminal 12. The first movable contact 16 may be integrated with the movable contact piece 13. The second movable contact 17 may be integrated with the movable contact piece 13.

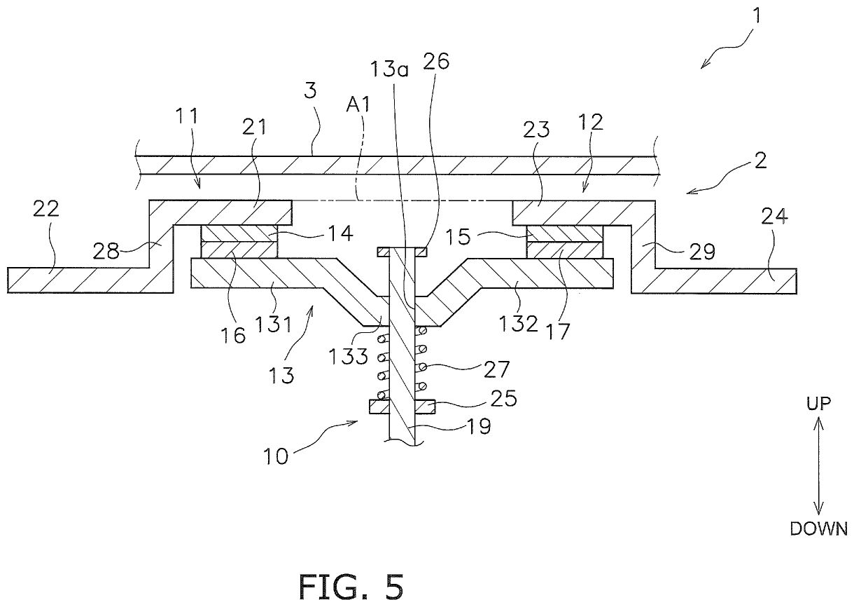

The shape or arrangement of the movable contact piece 13 may be changed. For example, the movable contact piece 13 is not limited to a linear shape as in the above-described embodiment, and may have another shape. FIG. 5 is a diagram showing a part of the relay according to a first modification. As shown in FIG. 5, the movable contact piece 13 may have a shape that is bent downward. Specifically, the movable contact piece 13 includes a first portion 131, a second portion 132, and a third portion 133. The first portion 131 supports the first movable contact 16. The second portion 132 supports the second movable contact 17. The third portion 133 is located between the first portion 131 and the second portion 132. The drive shaft 19 is connected to the third portion 133. Specifically, the above-mentioned hole 13a is provided in the third portion 133. The drive shaft 19 is inserted into the hole 13a. The third portion 133 is located below the first portion 131 and the second portion 132. In this case, the stopper 26 can be arranged at a lower position than in the case where the third portion 133 is aligned linearly with the first portion 131 and the second portion 132. Therefore, the housing 3 can be miniaturized.

The configuration of the movable mechanism 10 may be changed. For example, the shape or arrangement of the holder 25 may be changed. The shape or arrangement of the contact spring 27 may be changed. The shape or arrangement of the stopper 26 may be changed.

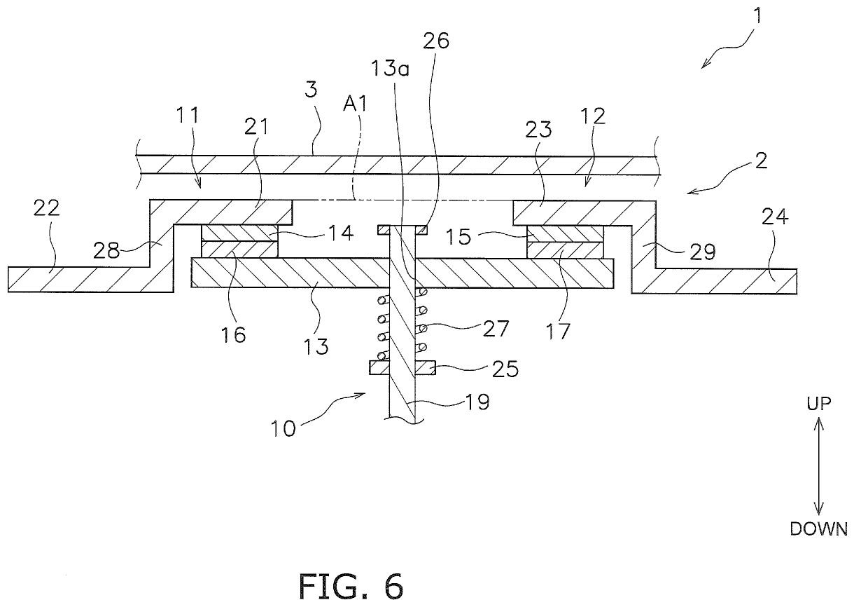

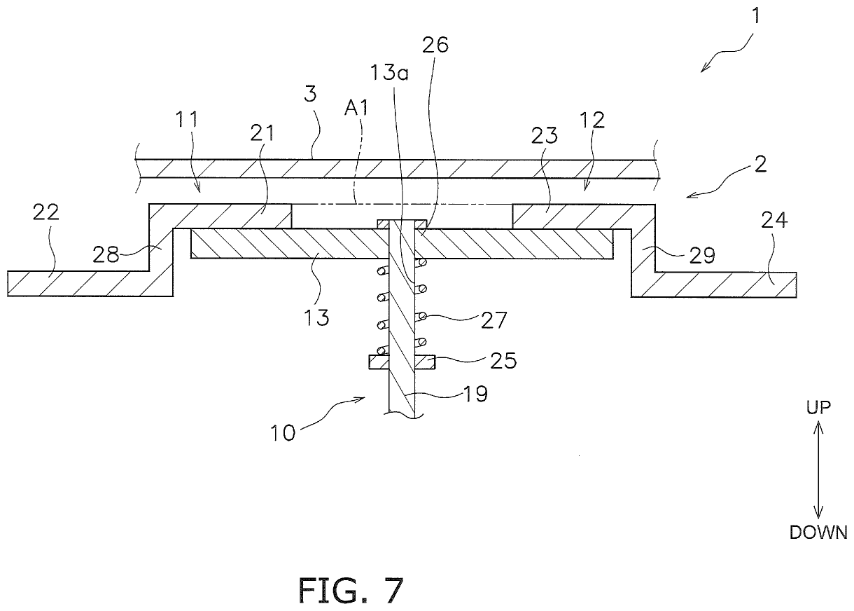

FIGS. 6 and 7 are diagrams showing a part of the relay 1 according to a second modification. FIG. 6 shows the drive shaft 19 at the closed position. When an overcurrent flows through the movable contacts 16 and 17 and the fixed contacts 14 and 15, the movable contacts 16 and 17 and the fixed contacts 14 and 15 may melt and be lost. FIG. 7 shows a part of the relay 1 when the movable contacts 16 and 17 and the fixed contacts 14 and 15 are lost. As shown in FIG. 7, when the movable contacts 16 and 17 and the fixed contacts 14 and 15 are lost, the movable contact piece 13 moves further upward than the position shown in FIG. 6. As a result, the movable contact piece 13 contacts the first fixed terminal 11 and the second fixed terminal 12. As a result, even if the movable contacts 16 and 17 and the fixed contacts 14 and 15 are lost, the energization of the movable contact piece 13 and the fixed terminals 11 and 12 can be ensured.

Further, when the movable contacts 16 and 17 and the fixed contacts 14 and 15 are lost, the drive shaft 19 and the stopper 26 move further upward than the closed position shown in FIG. 6. As shown in FIG. 7, in the relay 1 according to the second modification, the stopper 26 is located below the position A1 of the uppermost portions of the first fixed terminal 11 and the second fixed terminal 12 in a state where the drive shaft 19 is located above the closed position. In a state where the movable contacts 16 and 17 and the fixed contacts 14 and 15 are lost and the movable contact piece 13 contacts the first fixed terminal 11 and the second fixed terminal 12, the stopper 26 is located below the position A1 of the uppermost portions of the first fixed terminal 11 and the second fixed terminal 12. Therefore, even if the movable contacts 16 and 17 and the fixed contacts 14 and 15 are lost, it is possible to prevent the housing 3 from interfering with the stopper 26 and to reduce the size of the housing 3.

Note that FIG. 7 shows a state in which all of the movable contacts 16 and 17 and the fixed contacts 14 and 15 are lost. However, even when only a part of the movable contacts 16 and 17 and the fixed contacts 14 and 15 is lost, the stopper 26 is positioned below the position A1 of the uppermost portions of the first fixed terminal 11 and the second fixed terminal 12. Therefore, even if a part of the movable contacts 16 and 17 and the fixed contacts 14 and 15 is lost, it is possible to prevent the housing 3 from interfering with the stopper 26 and to reduce the size of the housing 3.

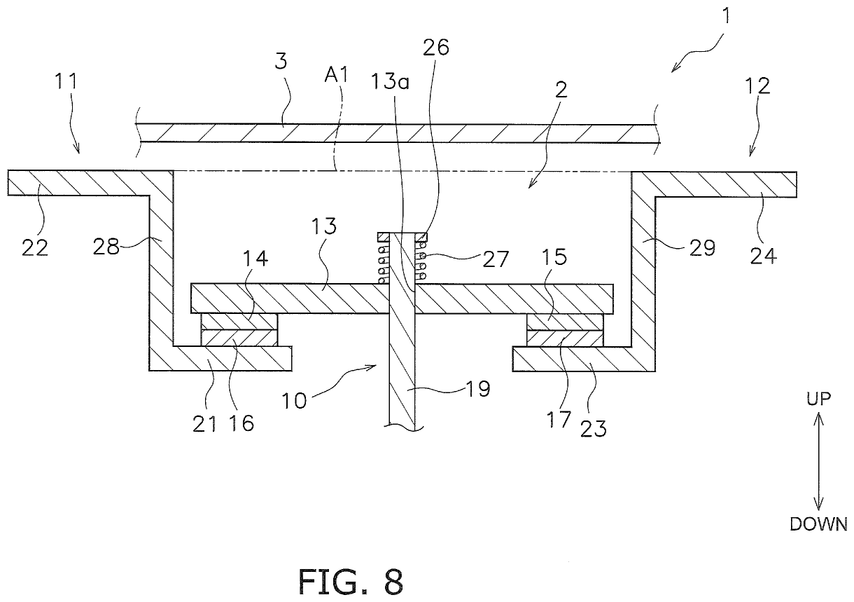

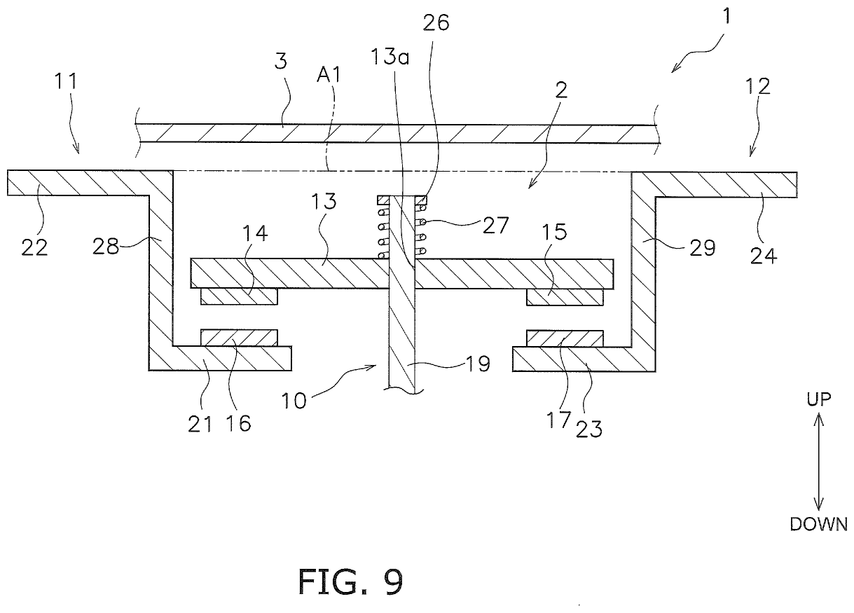

In the above embodiment, the drive shaft 19 and the movable contact piece 13 move upward so that the movable contacts 16 and 17 contact the fixed contacts 14 and 15. Further, when the drive shaft 19 and the movable contact piece 13 move downward, the movable contacts 16 and 17 are separated from the fixed contacts 14 and 15. However, the operating direction of the drive shaft 19 for opening and closing the contacts may be opposite to that of the above embodiment. FIGS. 8 and 9 are views showing a part of the relay 1 according to a third modification. FIG. 8 shows the drive shaft 19 at the closed position. FIG. 9 shows the drive shaft 19 at the open position.

In the relay 1 according to the third modification, the movable contact piece 13 is arranged above the first contact support portion 21 and the second contact support portion 23.

The first movable contact 16 is arranged above the first fixed contact 14. The second movable contact 17 is arranged above the second fixed contact 15. The open position is located above the closed position. The drive shaft 19 moves from the closed position to the open position by moving upward. The drive shaft 19 moves from the open position to the closed position by moving downward. When the drive shaft 19 is at the open position, the stopper 26 is located at the uppermost position in the moving range of the stopper 26. When the drive shaft 19 is at the open position, the stopper 26 is located below the position A1 of the uppermost portions of the first fixed terminal 11 and the second fixed terminal 12 in the housing 3.

In the third modification, the position A1 of the uppermost portions is the position of the upper surface of the first external terminal portion 22 and the upper surface of the second external terminal portion 24. In this case as well, it is possible to prevent interference between the housing 3 and the stopper 26 and to reduce the size of the housing 3 as in the above embodiment.

### REFERENCE SIGNS LIST

3 Housing
11 First fixed terminal
12 Second fixed terminal
13 Movable contact piece
14 First fixed contact
15 Second fixed contact
16 First movable contact
17 Second movable contact
19 Drive shaft
21 First contact support portion
23 Second contact support portion
26 Stopper
131 First portion
132 Second portion
133 Third portion

1. A relay comprising:
a first fixed contact;
a second fixed contact arranged apart from the first fixed contact in a left-right direction;
a first fixed terminal to which the first fixed contact is connected;
a second fixed terminal to which the second fixed contact is connected;
a first movable contact arranged below the first fixed contact;
a second movable contact arranged below the second fixed contact;
a movable contact piece to which the first movable contact and the second movable contact are connected, the movable contact piece being configured to move in a vertical direction;
a drive shaft extending from the movable contact piece in the vertical direction, the drive shaft being configured to support the movable contact piece so as to be movable relative to the drive shaft;
a stopper connected to the drive shaft above the movable contact piece, the stopper being configured to restrict an upward movement of the movable contact piece with respect to the drive shaft; and
a housing configured to accommodate the first fixed terminal, the second fixed terminal, the movable contact piece, the drive shaft, and the stopper, wherein
the drive shaft is configured to move to an open position and a closed position,
in a state where the drive shaft is at the open position, the first movable contact is separated from the first fixed contact, and the second movable contact is separated from the second fixed contact,
the closed position is located above the open position,
in a state where the drive shaft is at the closed position, the first movable contact contacts the first fixed contact, and the second movable contact contacts the second fixed contact,
the first fixed terminal includes a first uppermost portion in the housing,
the second fixed terminal includes a second uppermost portion in the housing, and
in a state where the drive shaft is at the closed position, the stopper is located below the first uppermost portion of the first fixed terminal and the second uppermost portion of the second fixed terminal in the housing.

2. The relay according to claim 1, wherein
the drive shaft is configured to move from the open position to the closed position via a contact start position,
in a state where the drive shaft is at the contact start position, the first movable contact and the second movable contact are configured to begin to contact the first fixed contact and the second fixed contact, and
the closed position is located above the contact start position.

3. The relay according to claim 1, wherein
in a state where at least one of the first movable contact, the first fixed contact, the second movable contact, or the second fixed contact is lost and the drive shaft is located above the closed position, the stopper is located below the first uppermost portion of the first fixed terminal and the second uppermost portion of the second fixed terminal in the housing.

4. The relay according to claim 1, wherein
the movable contact piece includes
a first portion configured to support the first movable contact,
a second portion configured to support the second movable contact, and
a third portion located between the first portion and the second portion, the drive shaft being connected to the third portion, and
the third portion is located below the first portion and the second portion.

5. The relay according to claim 1, wherein
the first fixed terminal and the second fixed terminal project outward from the housing in a direction perpendicular to the vertical direction.

6. The relay according to claim 1, wherein
the first fixed terminal includes a first contact support portion to which the first fixed contact is connected,
the second fixed terminal includes a second contact support portion to which the second fixed contact is connected,
the first contact support portion extends in a direction perpendicular to the vertical direction, and
the second contact support portion extends in the direction perpendicular to the vertical direction.

7. A relay comprising:
a first fixed contact;
a second fixed contact arranged apart from the first fixed contact in a left-right direction;
a first fixed terminal to which the first fixed contact is connected;
a second fixed terminal to which the second fixed contact is connected;
a first movable contact arranged above the first fixed contact;
a second movable contact arranged above the second fixed contact;
a movable contact piece to which the first movable contact and the second movable contact are connected, the movable contact piece being configured to move in a vertical direction;
a drive shaft extending from the movable contact piece in the vertical direction, the drive shaft being configured to support the movable contact piece so as to be movable relative to the drive shaft;
a stopper connected to the drive shaft above the movable contact piece, the stopper being configured to restrict an upward movement of the movable contact piece with respect to the drive shaft; and
a housing configured to accommodate the first fixed terminal, the second fixed terminal, the movable contact piece, the drive shaft, and the stopper, wherein
the drive shaft is configured to move to an open position and a closed position,
in a state where the drive shaft is at the open position, the first movable contact is separated from the first fixed contact, and the second movable contact is separated from the second fixed contact,
the open position is located above the closed position,
in a state where the drive shaft is at the closed position, the first movable contact contacts the first fixed contact, and the second movable contact contacts the second fixed contact,
the first fixed terminal includes a first uppermost portion in the housing,
the second fixed terminal includes a second uppermost portion in the housing, and
in a state where the drive shaft is at the open position, the stopper is located below the first uppermost portion of the first fixed terminal and the second uppermost portion of the second fixed terminal in the housing.

8. The relay according to claim 7, wherein
the first fixed terminal and the second fixed terminal project outward from the housing in a direction perpendicular to the vertical direction.

9. The relay according to claim 7, wherein
the first fixed terminal includes a first contact support portion to which the first fixed contact is connected,
the second fixed terminal includes a second contact support portion to which the second fixed contact is connected,
the first contact support portion extends in a direction perpendicular to the vertical direction, and
the second contact support portion extends in the direction perpendicular to the vertical direction.
